(19) United States
(12) Patent Application Publication
(10) Pub. No.: US 2017/0024384 A1
(43) Pub. Date: Jan. 26, 2017

(54) SYSTEM AND METHOD FOR ANALYZING AND SEARCHING IMAGERY

(71) Applicant: NETRA SYSTEMS INC., Surrey (CA)

(72) Inventor: Shashi KANT, Wellesley, MA (US)

(21) Appl. No.: 15/301,698

(22) PCT Filed: Sep. 2, 2014
(86) PCT No.: PCT/CA2014/050834

§ 371 Date: Oct. 3, 2016

(51) Int. Cl. G06F 17/30

(52) U.S. Cl. CPC G06F 17/3028; G06F 17/30256; G06F 17/30271; G06F 17/30327

(57) ABSTRACT

Still and moving images that are stored on a network are expressed as feature vectors, which are then indexed in inverted indices. Hashes of the feature vectors are also stored in a hash database, with each set of similar hashes being placed in bucket. A visual search query is received and expressed as feature vectors, which are then hashed. Matches for the hashed query are searched for in the hash database to quickly find buckets of closely matching images. The feature vectors represented by the matched buckets may optionally be looked through in the indices to find closer, or fewer matches. When multiple inverted indices are searched, they are done so simultaneously, after which the results are aggregated and ordered according to a similarity metric.

### TECHNICAL FIELD

The present invention generally relates to techniques for analyzing, indexing and searching for and retrieving visual information, and more particularly to the use of imagery-based queries to find and retrieve visual information from imagery such as photos and video.

### BACKGROUND

Video and photos, hereinafter referred to as imagery, constitute the bulk of information now being generated. The proliferation of video cameras and mobile phones has resulted in a surge of imagery data that has become increasingly challenging to navigate. Traditional approaches to the search of imagery use metadata such as human-generated tags (i.e. textual descriptors) and/or date/time/location information such as EXIF (Exchangeable image file format) metadata. Since only a small fraction of imagery is tagged, a limit is effectively placed on the amount of imagery that can actually be searched using textual descriptors. Further, there is often variability in human tagging. For example, one person might tag a photo as “beach vacation” and another might tag the same or similar photo as “seaside holiday”. This, in turn, affects the quality and relevance of search results.

Kamel et al. describe a multi-bin search providing large-scale content-based image retrieval (Int J Multimed Info Retr, 3 Jul. 2014). Sud et al. in U.S. Pat. No. 8,589,410 and US patent application publication No. 20140074852 disclose web-scale visual search capable of using a combination of visual input modalities are provided. Petrou, in US patent application publication No. 20110125735, discloses a search system that processes a visual query by sending it to a plurality of parallel search systems, each implementing a distinct visual query search process. Lawler et al., in US patent application publication No. 20110167053, disclose a system that can analyze a multi-dimensional input establishing a search query based upon extracted features from the input. Pattern recognition and image analysis can be applied to the image input. Yang et al., in US patent application publication No. 20120243789, discloses categorizing images by detecting local features for each image; applying a tree structure to index local features in the images; and extracting a rank list of candidate images with category tags based on a tree indexing structure to estimate a label of a query image.

### SUMMARY OF INVENTION

Embodiments of the present invention relate to systems, methods, and computer-readable storage media for, among other things, providing a system for visual indexing and search that is capable of using a combination of visual input modalities, such as an image, a portion of an image, a collection of images, a video, a portion of a video, a collection of videos, or a combination thereof. As such, content-based search approaches, rather than tag-based, are used to locate objects of interest within different types of imagery. Nevertheless, textual search terms may also be included with the visual, content based search terms to form a combined query.

Embodiments of the invention include receiving a search query for imagery; selecting one or more indices in which to search based on the context of the query; searching the selected indices using descriptor, Trie-based and map-reduce principles; and providing at least one result.

In one aspect, the present invention is directed to a method for searching imagery comprising the steps of: storing, by one or more processors, a plurality of inverted indices in computer readable memory, each inverted index comprising first feature vectors and representing one or more types of visual descriptor of the imagery, wherein at least some of the types are different to others of the types; receiving, by said processors, a visual query input; determining, by said processors, a context of the visual query input; selecting, by said processors based on the determined context, one or more of the inverted indices; looking up, by said processors, the visual query input in the selected inverted indices.

The method may also include: segmenting the visual query input into a plurality of blobs; calculating one or more second feature vectors for the visual query input; determining which of the types of visual descriptor said second feature vectors correspond to; looking up each second feature vector simultaneously; retrieving a link for each of the one or more matches from the inverted indices, each link being an address on a network of a piece of imagery; and/or providing said links to a user computing device connected via the network to said processors.

The method may further include: hashing, by said processors, the first feature vectors to form first hashes; storing the first hashes in groups in a database, wherein: each group represents one or more types of visual descriptor of the imagery; at least some of the types are different to others of the types; each group is divided into buckets; and each bucket comprises similar first hashes; and prior to selecting one or more of the inverted indices: hashing, by said processors, said second feature vectors to form one or more second hashes; selecting, by said processors based on the determined context, one or more of the groups of first hashes; and searching in the selected groups, by said processors, for one or more matches between said second hashes and said buckets. The looking up in the selected inverted indices may exclude looking up in portions of the selected inverted indices that do not correspond to said matched buckets. The method may include: ordering the matches of the first feature vectors according to a multi-dimensional similarity calculation; retrieving a link for each of said ordered matches from the inverted indices, each link being an address on a network of a piece of imagery; and providing said links to a user computing device connected via the network to said processors.

In another aspect, disclosed herein is a computer readable storage medium for indexing and searching imagery, said storage medium storing computer readable instructions, which, when executed by one or more processors cause a server to: store a plurality of inverted indices, each inverted index comprising first feature vectors in a data structure conducive to range queries and representing one or more types of visual descriptor of the imagery, wherein at least some of the types are different to others of the types; receive a visual query input; segment the visual query input into a plurality of blobs; calculate a second feature vector for each blob; determine a context of the visual query input by determining which of the types of visual descriptor said second feature vectors correspond to; select, based on the determined context, a plurality of the inverted indices; look up said second feature vectors simultaneously in the selected inverted indices.

The computer readable storage may cause the server to: hash the first feature vectors to form first hashes; store the first hashes in groups in a database, wherein: each group represents one or more types of visual descriptor of the imagery; at least some of the types are different to others of the types; each group is divided into buckets; and each bucket comprises similar first hashes; and prior to selecting the plurality of inverted indices: hash said second feature vectors to form one or more second hashes; select, based on the determined context, one or more of the groups of first hashes; and search in the selected groups for one or more matches between said second hashes and said buckets; wherein the looking up in the selected inverted indices excludes looking up in portions of the selected inverted indices that do not correspond to said matched buckets.

Also disclosed herein is a server for indexing and searching imagery configured to: store a plurality of inverted indices each inverted index comprising first feature vectors in a Trie data structure and representing one or more types of visual descriptor of the imagery, wherein at least some of the types are different to others of the types; receive a visual query input; segment the visual query input into a plurality of blobs; calculate a second feature vector for each blob; determine a context of the visual query input by determining which of the types of visual descriptor said second feature vectors correspond to; select, based on the determined context, a plurality of the inverted indices; look up said second feature vectors simultaneously in the selected inverted indices.

The server may be further configured to: hash the first feature vectors to form first hashes; store the first hashes in groups in a database, wherein: each group represents one or more types of visual descriptor of the imagery; at least some of the types are different to others of the types; each group is divided into buckets; and each bucket comprises similar first hashes; and prior to selecting the plurality of inverted indices: hash said second feature vectors to form one or more second hashes; select, based on the determined context, one or more of the groups of first hashes; and search in the selected groups for one or more matches between said second hashes and said buckets; wherein the looking up in the selected inverted indices excludes looking up in portions of the selected inverted indices that do not correspond to said matched buckets.

The Summary is provided to introduce a selection of concepts in an abbreviated form that are further described below in the Detailed Description. The Summary is not intended to identify key features or essential features of the claimed subject matter, nor is it intended to be used as an aid in determining the scope of the claimed subject matter.

### BRIEF DESCRIPTION OF THE DRAWINGS

The following drawings illustrate embodiments of the invention, which should not be construed as restricting the scope of the invention in any way.

FIG. 1 is a flowchart representing the creation, query, selection and searching of imagery indices.

FIG. 2 shows a schematic representation of a system for searching imagery according to an embodiment of the present invention.

FIG. 3 is a flowchart for the indexing of imagery.

FIG. 4 is a flowchart for extracting blobs from imagery and using them to create feature vectors.

FIG. 5 is a flowchart for extracting and indexing blobs from video.

FIG. 6 is a flowchart showing a blob being written to one or more indices and a hash database.

FIG. 7 is a flowchart for storing feature vectors in an auxiliary database.

FIG. 8 shows a schematic representation of locality sensitive hashing using visual descriptor feature vectors.

FIG. 9 is a flowchart for the processing of an imagery query.

FIG. 10 is a flowchart for querying one or more indices using feature vectors.

FIG. 11 is a flowchart showing nearest neighbor searching using MinHash and locality sensitive hashing.

FIG. 12 is a flowchart for querying an auxiliary feature vector database.

### DETAILED DESCRIPTION

### A. GLOSSARY

Blob—A Binary Large Object. This can be used to refer to a collection of binary data stored as a single entity, which represents a region of imagery. It is sometimes expressed as a BLOB or BLOb.

Descriptor—A mathematical value or set of values that represents a visual characteristic or feature of a piece of imagery. Such characteristics may be shape, colour, a colour histogram, texture, edge, an edge histogram, gradient, a histogram of gradients, motion etc. There may be numerous descriptors for a given piece of imagery. The MPEG-7 set of descriptors may be used, for example. The mathematical representation of a descriptor is typically a vector, or ordered list of one or more numbers, known as a feature vector. Examples of descriptors include SIFT (Scale-invariant feature transform), SURF (Speeded Up Robust Features) and ORB (Oriented FAST (Features from accelerated segment test) and Rotated BRIEF (Binary Robust Independent Elementary Features)). A descriptor may be referred to as a visual descriptor.

Feature Vector—An n-dimensional set of numeric values (vector) that represents an object's characteristics (e.g. shape, color, etc.)

Hash—A condensed representation, in a predetermined format, of a selection of data that can be in various diverse formats. A hash function takes a group of characters (called a key) and maps it to a value of a certain length (called a hash value or hash). The hash value is representative of the original string of characters, but is normally smaller than the original.

Imagery—Any of a photo, a video, a video clip, a frame of a video, a painting, a drawing, a sketch, a picture, a collage, a diagram, a graph, a flowchart, a technical drawing, a blueprint, a negative, a hologram, a doodle, graffiti, an x-ray, a scan, a transparency, a presentation, a design, a pattern, a logo, a badge, any other form of image whether still or moving, a portion of any of the foregoing, or a combination of one or more of the foregoing.

Inverted index—A type of index, which, for example, points to documents that contain the word that is looked up. This is to be contrasted with a regular, or forward index, which points to the location of words in a given document, such as a book. In the context of the present disclosure, a ‘word’ should be read to mean ‘feature vector’ and a ‘document’ should be read to mean a ‘piece of imagery’. An inverted index is often also referred to simply as an index. k-NN search—k-nearest neighbor searching is widely used for image searching. It basically involves finding the k closest matches to a search term.

Locality sensitive hashing (LSH)—A method of probabilistically grouping large amounts of high-dimensional data for quicker comparison. The items of data are hashed (mapped into a pre-defined representation) so that similar data items can be mapped into the same buckets with a high degree of probability, the number of buckets being much smaller than the universe of possible data items. MinHash is an example of locality sensitive hashing. Other forms of hashing include Spectral Hashing and Spherical Hashing.

Piece of imagery—Used to refer to a single item of imagery, whether it be a still image or a video clip, for example, such item being either searchable or a search term, or both.

Tag—A textual description for the content of imagery, usually written and associated with the imagery by a person, or picked by the person from a list of automatically generated suggestions that are derived from a tag or title already written by the person.

Trie—An ordered tree data structure. All the descendants of a node in the tree have a common prefix of the string associated with that node, and the root or primary node is associated with the empty string. Also known as a digital tree, a radix tree or prefix tree.

### B. OVERVIEW

Visual attributes such as colour, shape, texture, etc. have been shown to be among the key factors used by humans for visual object identification and classification. With the growth in the quantity of imagery, particularly video and photography, there has become a clear need for content based search methods. While searching for imagery, a query by example is employed that mirrors the keyword based paradigm made popular by major textual search engines such as Google™ or Bing™. Usability studies have shown the ability to crop one or more objects of interest from within query images and run queries with them to provide powerful and intuitive searching capabilities while enabling discovery and exploration. Furthermore, the ability to perform iterative searches using a selection of images, for inclusion in or exclusion from results and repeat searches, is a paradigm that allows users to successively approximate to a desired result set.

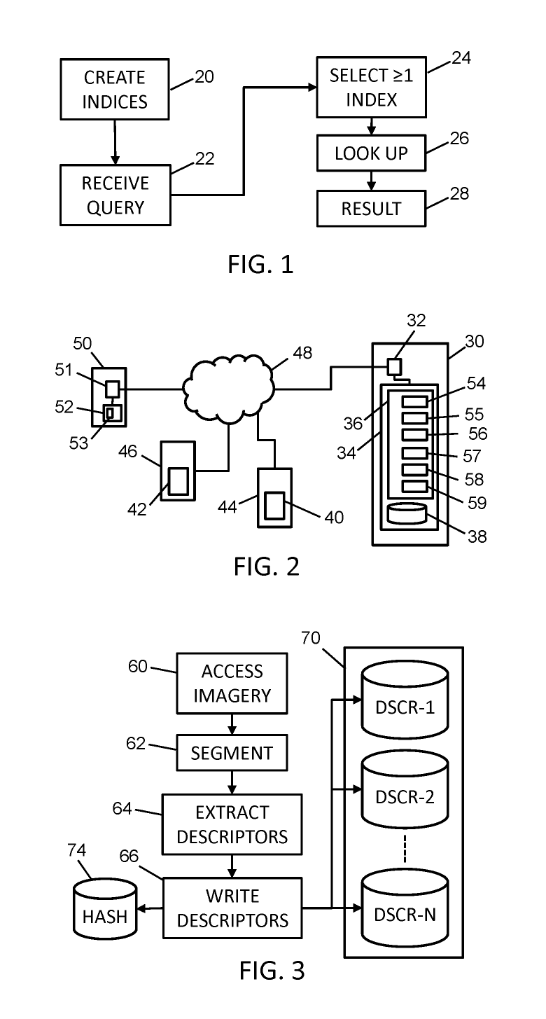

Referring to FIG. 1, an exemplary embodiment of a method for search imagery in accordance with the invention is shown as a flowchart. In step 20, one or more inverted indices are created, where each inverted index includes some or all of the feature vectors of the imagery that is available to be indexed and subsequently searched. In combination, all indices may have all the feature vectors, or all pieces of imagery will have at least one of its feature vectors indexed. Each feature vector in the indices points to one or more pieces of imagery. For example, a single feature vector in an index may point to multiple pieces of imagery, which all have something very clearly in common with each other. In step 22, a visual query is received that may be simple, such as a single shape, or complex, such as comprising multiple shapes and/or colours, or even more specific features. Based on an analysis of the query and its conversion into one or more feature vectors, one or more of the inverted indices are selected in step 24, depending on the context of the query, or, more particularly, on the type of descriptor(s) that the query represents. In step 26, the selected index or indices are consulted to look up the feature vectors of the search query. When a match between the search query feature vector(s) and one or more of the feature vector(s) in the indices is found, the result of the match is displayed to the user in step 28. The result includes one or more links to the imagery corresponding to the matched feature vector(s). A match need not be a perfect match, but may just be a close match or the closest match found.

Referring to FIG. 2, an exemplary embodiment of a system 10 for search imagery in accordance with the invention is shown, which provides for a large scale visual search that is capable of using a combination of multiple visual input modalities. The system 10 comprises one or more servers 30 having one or more processors 32 in communication with one or more computer-readable storage media 34, or computer readable memory or storage. One or more programs 36 are maintained in the computer-readable storage media 34 that create, maintain and access one or more indices 38, which are maintained in the computer-readable storage media 34. The indices 38 include image data, i.e. feature vectors, that describe imagery 40, 42 stored on various other servers 44, 46 connected to the server 30 via a network 48, which may be the internet, an intranet, a cellular data network or a combination of the foregoing.

A user computing device 50 connected to the network 48 is used to submit a visual search query to the system 10. The user device 50 may be, for example a smart phone, a tablet, a laptop, a desktop or other mobile or static electronic computing device. The device 50 includes one or more processors 51 connected to computer readable memory 52 having stored therein computer readable instructions 53 which, when executed by the processor(s) 51, cause the device to send a visual query to the system 10 and to receive from the system the results of such query. The device 50 is also capable, based on links provided with the results, of accessing the particular items of imagery 40, 42 that have been identified by the search. In some embodiments, the computer readable instructions 53 may be considered to be part of the system 10.

The program(s) 36 of the system 10 comprise a crawler 54 that accesses imagery stored on the internet or other network; a blob extractor module 55 that segments a piece of imagery into portions and calculates feature vectors for them; an indexing module 56 that stores the feature vectors and links to the imagery in one or more inverted indices; a query receiving module 57 that receives a visual input as a search query; a query parser 58 that converts the visual input into one or more feature vectors; and a visual input matching module 59 that matches the one or more feature vectors of the visual query input with the feature vectors in the indices 38 to identify at least one matching piece of the imagery 40, 42. Note that the distinction between the functionalities of each module is not necessarily sharp, and is given here as an example only.

### C. INDEXING

Referring to FIG. 3, a quantity of imagery is accessed in step 60 by the imagery crawler 54. Each piece of imagery is segmented, in step 62, into one or more blobs. Segmentation may be performed using a grid; object detection; motion detection; background subtraction; object persistence in multiple channels, such as HSV (Hue saturation value), RGB (Red, green, blue) or YCbCr (an encoding of RGB information); pixel filtering in the channels to reduce noise; and/or background removal before performing contour detection.

Descriptors for each blob are then extracted in step 64 by the blob extraction module 55. Each descriptor representation comprises mathematical values forming a feature vector, which describes a set of pixels that depict one or more edges or boundary contours of a piece of imagery. Extracting the descriptors may involve contour detection or multi-phase contour detection. In multi-phase contour detection, the outline of a shape or primary object in the imagery is first detected, followed by the detection of constituent edges, shapes or constituent objects within the primary object. For example, a car may be a primary object and its wheel hubs, windows, doors and light blocks may be constituent or secondary objects. Following this, the feature vectors for the descriptors are written, in step 66, to their respective indices 70 by the indexer module 56. These indices may be, for example, descriptor indices DSCR-1, DSCR-2, . . . DSCR-N, each of which is an inverted index. The indices 70 together comprise feature vectors that correspond to the imagery accessed in step 60. There is typically more than one index, with each index representing a different contextual aspect of the imagery. For example, one index may represent shape, another index colour, texture, contour; etc. Other indices might represent dynamic characteristics such as gait, expression, gestures etc. In the embodiments, shape, edge, color, texture and motion descriptors, gradient-based representations and/or histograms of gradients may be included in the inverted indices. In some embodiments each descriptor is persisted in a separate index. In other embodiments, multiple descriptors are combined and persisted in the same index. There may be some overlap between the descriptors represented by the indices and the feature vectors stored therein.

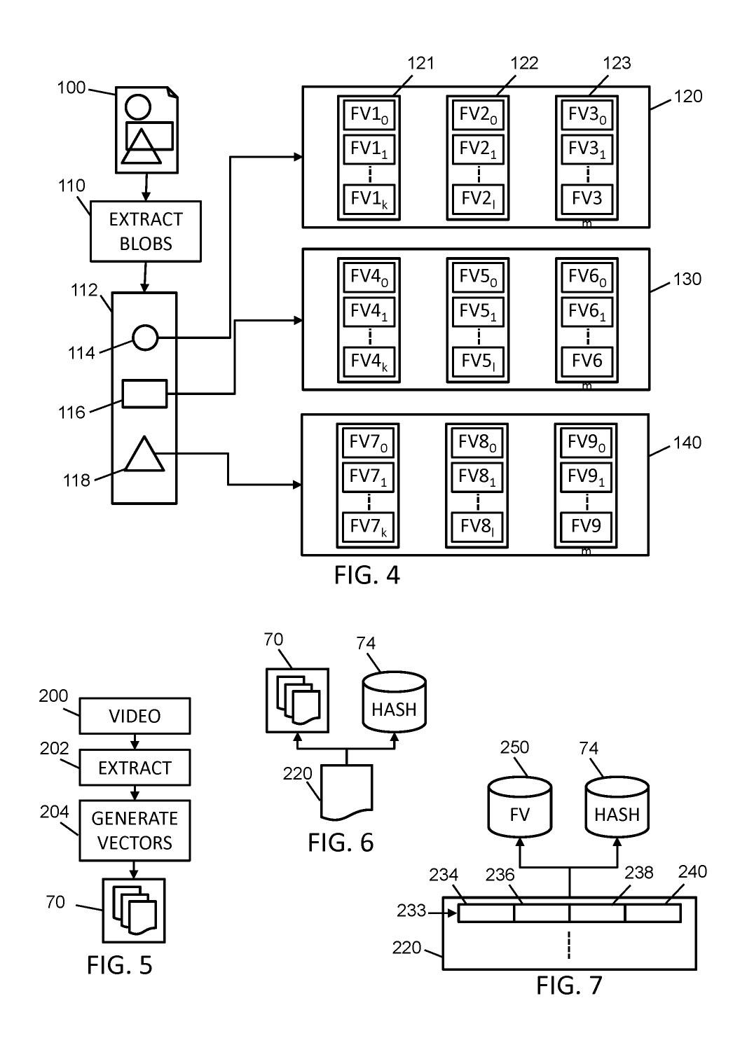

Moving ahead to FIG. 4, a still image 100, such as the Louvre by moonlight, may include clearly pronounced shapes, such as a circle, a rectangle and a triangle, which may be considered to be the main features of the image. In step 110 of an exemplary embodiment of the invention, these main features are extracted from the image 100 to form separate blobs 112 by the blob extraction module 55. The first blob 114 representing a circle is expressed as one or more feature vectors 120. The first feature vector 121 may represent, for example, the overall shape of the first blob 114, how close it is to a true circle and its position or coordinates, and typically comprises a series of numbers FV1ₒ to FV1ₖ. The second feature vector 122 may, for example, represent the average colour of the first blob 114, the range of colours in it, and the distribution of the colours in it. This second feature vector 122 will also typically comprise a series of numbers denoted FV2ₒ to FV2ₗ. The third feature vector 123 may, for example, represent texture within the first blob 114, such as contour lines that have been detected. This third feature vector 123 will also typically comprise a series of numbers denoted FV3ₒ to FV3ₘ. Likewise, the second blob 116 is defined in terms of feature vectors 130 and the third blob 118 is represented in terms of feature vectors 140. Each of these feature vectors may be indexed in one or more of the indices 70 by the indexer module 56.

FIG. 5 shows a flowchart showing how an inverted index or indices for a video can be made. First, in step 200, the video is accessed by the imagery crawler 54. In step 202, objects are extracted from the video by the blob extractor module 55. These objects may be foreground objects, background objects, or both. Motion detection and other appearance modeling may be used. In step 204, feature vectors for the blobs are created. Such feature vectors are created, at least in part, by segmenting the piece of imagery into a plurality of image segments and performing contour detection (or multi-phase contour detection) on each segment. Then, the feature vectors are indexed by the indexer module 56 in the inverted indices 70 (note a different symbol is now used).

Referring back to FIG. 3, the feature vectors for the blobs are stored in the descriptor indices 70 in the form of a Trie data structure. A Trie data structure allows for fast efficient range queries. Other data structures that are also conducive to range queries may be used. Other forms of performing a range query might be iterative pruning, wherein repeated queries are iteratively performed with decreasing tolerance bands around the values until results of a desired size are obtained. The results are then ordered according to similarity metrics such as Jaccard Distance.

In addition, hashes of the feature vectors are also stored in a hash database 74, which permits a k-NN (k-nearest neighbor) search, for example using LSH (Locality Sensitive Hashing), such as MinHash, or using Spectral or Spherical Hashing. A k-nearest neighbor search allows for fast retrieval of imagery similar to the query. Similar pieces of imagery will have similar feature vectors, which in turn will have similar hashes. Since similar hashes are grouped together in a common bucket, the corresponding similar pieces of imagery can be identified by matching a search term with a bucket. The feature vectors of the search term are hashed as well as the feature vectors of the stored imagery, so that the hashes of both the query and the imagery are compared.

FIG. 6 shows that the inputs 220 derived from the sources imagery, such as source imagery name, blob coordinates and feature vectors are used for writing both to the feature vector indices 70 and the hash database 74. FIG. 7 shows that the input data 220 relating to the imagery may comprise rows 233 of data, such as row ID 234, source imagery name 236, blob coordinates 238 and feature vector set 240. As well as being hashed for storage in the hash database 74, the feature vectors 240 may also be stored, rather than indexed, in an auxiliary database 250. The benefits of such an auxiliary database are that range queries can be performed, such as using iterative pruning, to arrive at a result set which can be compared pair-wise with the query image and ordered by relevance.

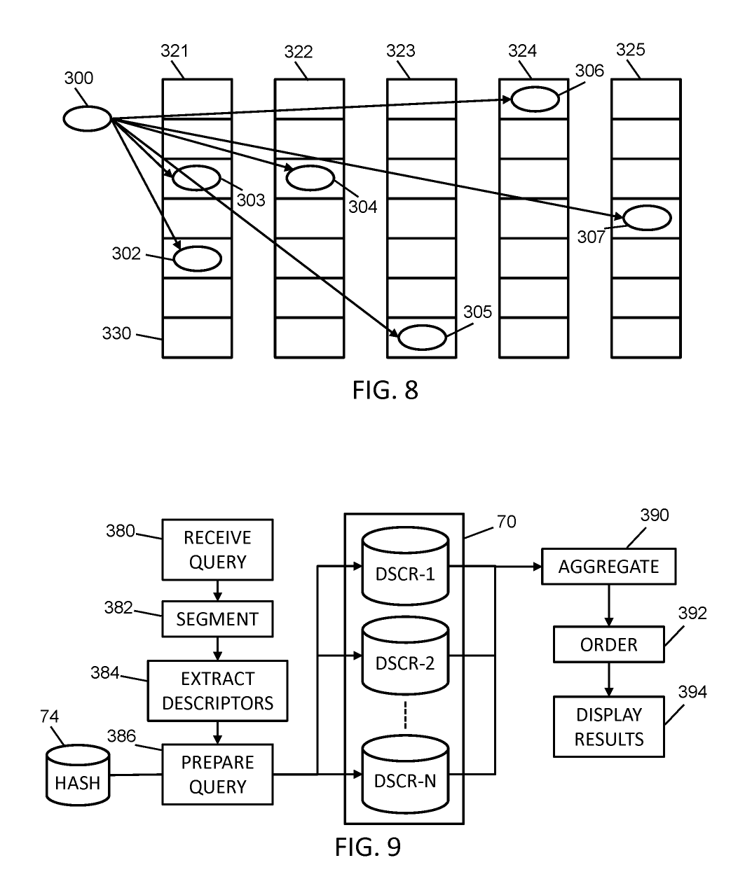

FIG. 8 shows an example of a blob 300 and its hashes 302-307, each one of which corresponds to a feature vector in the indices 70, such as feature vector 121 of FIG. 4. The hashes 302-307 are stored in the hash database 74. The hashes 302-307 are grouped into groups according to type of descriptor, and further, within each group, into bands (buckets) 321-325 having sections 330. Each section 330 contains zero, one or more hashes. Each band can also be referred to as a hash.

### D. QUERYING

The system of the present invention is configured to receive search queries via a variety of visual input modalities and to return image-based search results based upon the received input. An interface may be provided that gives an intuitive, touch-friendly user experience that enables a user to flexibly formulate search queries using a combination of input modalities (e.g., text, image, sketch, and collage) and to switch between and combine different input modalities within the same search session. The interface may include a search canvas or window that enables users to compose a complex query, such as by drawing a sketch or inputting an image or drawing.

Upon receiving a search query having a visual query input, for example an image, a sketch, a video clip or a combination thereof, the visual query input is converted into a descriptor based representation, i.e. feature vectors. Such conversion may involve segmentation of the image or of one or more the frames of the video clip followed by multi-phase contour detection. The feature vectors of all the imagery that is being searched are compared, directly or indirectly, with the feature vectors of the visual query input to identify at least one piece of imagery that matches the visual query input.

In some embodiments, the visual query input may be converted into gradient-based representations and/or histograms of gradients and compared against like data included in one of the inverted indices.

Referring to FIG. 9, a flowchart is shown for the processing of a query. A search query is received, by the query receiving module 57, in step 380. The search query has a visual query input, for example an image, crop of one/more objects of interest, a sketch, a collage, a video clip, a video clip with objects of interest marked therein, or any combination thereof. The system of the present invention is configured to receive search queries via a variety of visual input modalities.

In the embodiments, the visual query input may be converted to a single feature vector or, depending on its complexity, may be converted into multiple feature vectors.

The visual query input is therefore segmented, if necessary, in step 382 into multiple query blobs by the query parser module 58. Descriptors for each query blob are then extracted in step 384. The descriptors of the query blobs are then expressed as feature vectors by the query parser module 58 in preparation, in step 86, of the query to be applied to the hash database and/or the indices 70, by the query input matching module 59. In general, but not necessarily, the query will be applied to both the hash database 74 and the descriptor indices 70. Where the input query is split into multiple feature vectors, each query feature vector is looked up in the corresponding feature vector index or indices.

The hash database 74 is consulted by the query matching module 59 to quickly find one or more buckets corresponding to the query blobs. If, for example, the hash database 74 returns only a few hits (e.g. 25 hits), then the descriptor indices 70 may not be searched, as there will be little advantage in doing so. Instead, the feature vectors contained in the identified bucket(s) will be looked up directly in the indices 70 to find the pieces of imagery to which they correspond. Alternately, the feature vectors may be looked up in the auxiliary feature vector database 250.

If the number of hits from the hash database 74 is high (e.g. 500 hits), an optional, second-pass lookup is performed against the hits in the Trie-based indices 70. The query is federated to one or more of the Trie-based indices DSCR-1, DSCR-2, . . . DSCR-N. Each query blob's set of feature vectors is looked up within the hits in the indices 70 in order to identify at least one piece of imagery that matches the visual query input.

The choice of indices 70 searched depends on the context of the search query. For example, if the search query is grey scale imagery, then the hashes in the hash database and feature vectors in the indices 70 that include colour will not be looked up. If the search query has pronounced detail, then the shape hashes and shape index or indices will be looked up. Examples of indices include colour; colour combined with shape; colour combined with contour and shape; color combined with edge and texture, etc.

If more than one index is searched then the search results are aggregated in step 390. The results are ordered in step 392 for higher accuracy, according to relevance, newness or some other criteria, and then displayed to the user in step 394.

Results may be displayed, in step 394, as a list of thumbnails with or without textual descriptions and/or tags if present; in a grid of thumbnails; or in any other format whereby the user can click on the thumbnail or other link to navigate to the corresponding piece of imagery.

For multiple query blobs, the above process is parallelized and each query blob is processed independently, aggregated and then sorted using a similarity metric. This approach is analogous to the Map-Reduce programming model.

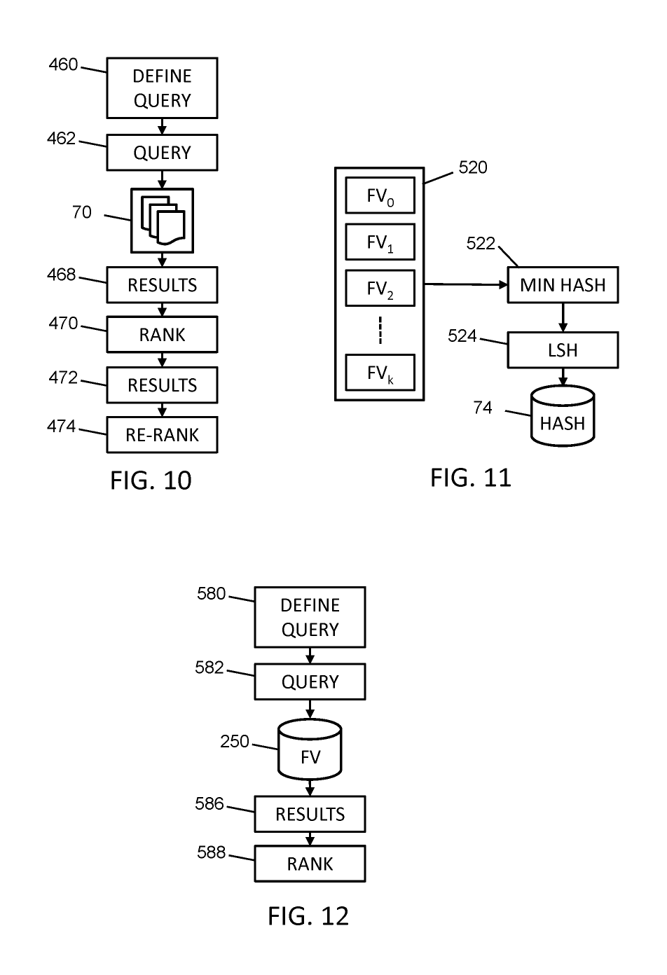

Referring to FIG. 10, a more detailed flowchart is shown of a query being applied to the feature vector indices 70. In step 460, the query is defined, which may include optional filters, weights and requested fields. In step 462, the query is applied to the feature vector indices 70. In step 468, the results are obtained from the feature vector indices 70. These results are then ranked, in step 470, according to whether they contain the requested fields. In step 472, the results are obtained and then in step 474 they are optionally re-ranked based on a multi-dimensional similarity calculation. This re-ranking, which is effectively a third pass of ordering, is typically done using a multi-dimensional similarity metric, such as Tanimoto distance, using the query's feature vector set and the feature vector set of the search results.

FIG. 11 shows a k-NN search performed in the hash database 74. One or more of the feature vectors 520 of the input search query is subjected to a MinHash, or other suitable hashing process, in step 522. In step 524, LSH is applied to find matches of the hashed search query with the hashes in the hash database 74.

Referring to FIG. 12, a flowchart is shown for searching the auxiliary feature vector database 250 of FIG. 7. In step 580 a query is received and defined as a feature vector set with optional filters, weights and requested fields. In step 582, the query is applied to the auxiliary feature vector database 250. In step 586, the list of result rows from the auxiliary feature vector database is obtained and then ranked in step 588, according to a multi-dimensional similarity calculation.

### E. VARIATIONS

The variations include analyzing, indexing and searching other forms of signals outside of the visual spectrum such as audio signals, hyperspectral imaging, thermal infrared, ultrasound, full spectral, multi-spectral, chemical imaging and outputs from other sensors and measurements.

The foregoing has been a detailed description of illustrative embodiments of the invention. The subject matter of the present invention has been described with specificity to present exemplary embodiments. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” in relation to flowcharts may be used herein to connote different elements of methods employed, the term should not be interpreted as implying any particular order among or between various steps herein disclosed unless and except when the order of individual steps is explicitly described.

Various modifications and additions can be made without departing from the scope of this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

### F. INDUSTRIAL APPLICABILITY

The invention provides techniques that improve the quantity, quality and performance of indexing and visual search of a vast number of images. Still and moving images can be indexed and searched. Single or multiple visual input modalities and optionally a textual input can be used when formulating a query.

1. A method for searching imagery comprising the steps of:
storing, by one or more processors, a plurality of inverted indices in computer readable memory, each inverted index comprising first feature vectors and representing one or more types of visual descriptor of the imagery, wherein at least some of the types are different to others of the types;
receiving, by said processors, a visual query input;
determining, by said processors, a context of the visual query input;
selecting, by said processors based on the determined context, one or more of the inverted indices;
looking up, by said processors, the visual query input in the selected inverted indices.

2. The method of claim 1 wherein the first feature vectors in the inverted indices are stored in a Trie data structure.

3. The method of claim 1, wherein the types of visual descriptor include one or more of: shape; colour; colour gradient; colour histogram; texture; edge; edge histogram; gradient; histogram of gradient; and motion.

4. The method of claim 1, wherein said visual query input comprises one or more of a still image, a plurality of still images, a moving image and a plurality of moving images.

5. The method of claim 1 wherein the context is determined by said processors:
calculating one or more second feature vectors for the visual query input; and
determining which of the types of visual descriptor said second feature vectors correspond to.

6. The method of claim 5, wherein a plurality of second feature vectors are calculated for the visual query input and the looking up comprises looking up each second feature vector simultaneously.

7. The method of claim 5, wherein calculating one or more second feature vectors for the visual query input comprises segmenting the visual query input into a plurality of blobs.

8. The method of claim 5 wherein looking up comprises searching for one or more matches between said second feature vectors and the first feature vectors.

9. The method of claim 8 further comprising:
retrieving a link for each of the one or more matches from the inverted indices, each link being an address on a network of a piece of imagery; and
providing said links to a user computing device connected via the network to said processors.

10. The method of claim 8, further comprising:
hashing, by said processors, the first feature vectors to form first hashes;
storing the first hashes in groups in a database, wherein:
each group represents one or more types of visual descriptor of the imagery;
at least some of the types are different to others of the types;
each group is divided into buckets; and
each bucket comprises similar first hashes; and
prior to selecting one or more of the inverted indices:
hashing, by said processors, said second feature vectors to form one or more second hashes;
selecting, by said processors based on the determined context, one or more of the groups of first hashes; and
searching in the selected groups, by said processors, for one or more matches between said second hashes and said buckets.

11. The method of claim 10, wherein the looking up in the selected inverted indices excludes looking up in portions of the selected inverted indices that do not correspond to said matched buckets.

12. The method of claim 11, further comprising:
ordering the matches of the first feature vectors according to a multi-dimensional similarity calculation;
retrieving a link for each of said ordered matches from the inverted indices, each link being an address on a network of a piece of imagery; and
providing said links to a user computing device connected via the network to said processors.

13. The method of claim 1, further comprising storing the first feature vectors in an auxiliary database.

14. A computer readable storage medium for indexing and searching imagery, said storage medium storing computer readable instructions, which, when executed by one or more processors cause a server to:
store a plurality of inverted indices, each inverted index comprising first feature vectors in a data structure conducive to range queries and representing one or more types of visual descriptor of the imagery, wherein at least some of the types are different to others of the types;
receive a visual query input;
segment the visual query input into a plurality of blobs;
calculate a second feature vector for each blob;
determine a context of the visual query input by determining which of the types of visual descriptor said second feature vectors correspond to;
select, based on the determined context, a plurality of the inverted indices;
look up said second feature vectors simultaneously in the selected inverted indices.

15. The computer readable storage of claim 14, further storing computer readable instructions, which, when executed by one or more processors cause the server to:
hash the first feature vectors to form first hashes;
store the first hashes in groups in a database, wherein:
each group represents one or more types of visual descriptor of the imagery;
at least some of the types are different to others of the types;
each group is divided into buckets; and
each bucket comprises similar first hashes; and
prior to selecting the plurality of inverted indices:
hash said second feature vectors to form one or more second hashes;
select, based on the determined context, one or more of the groups of first hashes; and
search in the selected groups for one or more matches between said second hashes and said buckets;
wherein the looking up in the selected inverted indices excludes looking up in portions of the selected inverted indices that do not correspond to said matched buckets.

16. The computer readable storage of claim 15, further storing computer readable instructions, which, when executed by one or more processors cause the server to:
search for one or matches between said second feature vectors and the first feature vectors;
retrieve a link for each of the one or more matches from the inverted indices, each link being an address on a network of a piece of imagery; and
provide said links to a user computing device connected via the network to said processors.

17. The computer readable storage of claim 16, further storing computer readable instructions, which, when executed by one or more processors cause the server to order the matches of the first feature vectors according to a multi-dimensional similarity calculation.

18. The computer readable storage of claim 14, wherein the data structure is a Trie data structure.

19. A server for indexing and searching imagery configured to:
store a plurality of inverted indices each inverted index comprising first feature vectors in a Trie data structure and representing one or more types of visual descriptor of the imagery, wherein at least some of the types are different to others of the types;
receive a visual query input;
segment the visual query input into a plurality of blobs;
calculate a second feature vector for each blob;
determine a context of the visual query input by determining which of the types of visual descriptor said second feature vectors correspond to;
select, based on the determined context, a plurality of the inverted indices;
look up said second feature vectors simultaneously in the selected inverted indices.

20. The server of claim 19, further configured to:
hash the first feature vectors to form first hashes;
store the first hashes in groups in a database, wherein:
each group represents one or more types of visual descriptor of the imagery;
at least some of the types are different to others of the types;
each group is divided into buckets; and
each bucket comprises similar first hashes; and
prior to selecting the plurality of inverted indices:
hash said second feature vectors to form one or more second hashes;
select, based on the determined context, one or more of the groups of first hashes; and
search in the selected groups for one or more matches between said second hashes and said buckets;
wherein the looking up in the selected inverted indices excludes looking up in portions of the selected inverted indices that do not correspond to said matched buckets.
